(19) United States
(12) Patent Application Publication
(10) Pub. No.: US 2023/0216109 A1
(43) Pub. Date: Jul. 6, 2023

(54) THERMAL RESERVOIR FOR ELECTRIC VEHICLE

(71) Applicant: Polestar Performance AB, Göteborg (SE)

(72) Inventors: Jongseok Moon, Göteborg (SE); Kevin White, Göteborg (SE)

(21) Appl. No.: 17/566,565

(22) Filed: Dec. 30, 2021

(51) Int. Cl. H01M 10/6568; H01M 10/63; H01M 10/625; H01M 10/6556; H01M 10/6571; B60L 58/26

(52) U.S. Cl. CPC H01M 10/6568; H01M 10/63; H01M 10/625; H01M 10/6556; H01M 10/6571; B60L 58/26; H01M 2220/20

(57) ABSTRACT

A thermal regulation system for electric vehicle configured to convert an external source of electrical energy to an alternative supply of on board stored energy for use in conditioning a temperature of a battery pack, the thermal regulation system including a fluid circuit configured to circulate a heat conducting fluid medium, the fluid circuit comprising at least one mechanism for affecting at least one of a temperature change, pressure change, or a combination thereof to the heat conducting fluid medium, wherein the at least one mechanism is powered by electrical power from an external charging station, and a heat exchanger configured to enable a transfer of thermal energy between heat conducting fluid medium and a battery pack of an electric vehicle.

### TECHNICAL FIELD

The present technology is generally related to battery conditioning of an electric vehicle, and more particularly to the storage of energy from an external electric vehicle charging station (e.g., in the form of a pressure or temperature conditioned fluid) to regulate the temperature of the battery for optimal performance during use.

### BACKGROUND

Electric vehicles are becoming increasingly popular as consumers look to decrease their environmental impact and improve air quality. Instead of a traditional internal combustion engine, electric vehicles include one or more motors, powered by a rechargeable battery pack. A common battery pack is made up of one or more battery modules, each module containing a plurality of battery cells, which act as galvanic cells when being discharged by converting chemical energy to electrical energy, and electrolytic cells when being recharged by converting electrical energy to chemical energy.

As is well known, these battery cells can generate heat in use during recharge and discharge. A buildup of excessive heat within the battery pack can negatively affect charging and can also result in degradation in performance or output of the battery cells. Accordingly, the buildup of heat is typically discharged through an active cooling system, often through circulation of a heat conducting fluid medium through one or more fluid conduits adjacent to the battery pack to absorb at least some of the heat generated by the individual cells.

Unfortunately, conventional cooling systems are typically tied to the electric motors, and therefore are only configured to provide active cooling during operation of the vehicle (e.g., not during recharge). Moreover, such cooling systems for the battery pack ultimately draw their power from the rechargeable battery pack itself, which can adversely affect the operational range of the electric vehicle.

Conversely, relatively low temperatures within the battery pack, for example as a result of the vehicle being exposed to low ambient environmental conditions for an extended period of time, can also result in degradation in performance of the battery cells. In particular, low battery temperatures can result in a decrease in output and a decrease in recharging capacity, which also can adversely affect the operational range.

The present disclosure addresses these concerns.

### SUMMARY OF THE DISCLOSURE

Embodiments of the present disclosure provide an electric vehicle configured to harness electrical power provided by an external charging station to precondition a fluid to regulate the temperature of the rechargeable battery or other components (e.g., cabin heating/cooling, etc.) during recharge and subsequent use for optimal performance. In some embodiments, the external charging station can be configured to actively power a battery thermal regulation system configured to provide active heating or cooling during battery recharge, as well as to precondition the thermal regulation system for battery conditioning during subsequent use. For example, in some embodiments, the thermal regulation system can use power from an external charging station to pressurize a refrigerant, which after natural cooling can subsequently be run through an expansion valve to provide active cooling to the battery pack during operation.

Conversely, in some embodiments, the thermal regulation system can use power from an external charging station to power one or more resistive heaters to actively heat a fluid for subsequent use in raising or maintaining a desired temperature of the battery pack. Accordingly, embodiments of the present disclosure provide a battery thermal regulation system configured to convert an external source of electrical energy to one or more alternative supplies of onboard stored energy for later use.

One embodiment of the present disclosure provides a thermal regulation system for electric vehicle configured to convert an external source of electrical energy to an alternative supply of on board stored energy for use in conditioning a temperature of a battery pack, including a fluid circuit configured to circulate a heat conducting fluid medium, the fluid circuit comprising at least one mechanism for affecting at least one of a temperature change, pressure change, or a combination thereof to the heat conducting fluid medium, wherein the at least one mechanism is powered by electrical power from an external charging station, and a heat exchanger configured to enable a transfer of thermal energy between heat conducting fluid medium and a battery pack of an electric vehicle.

In one embodiment, the fluid circuit further comprises a pump configured to actively circulate the heat conducting fluid medium through the fluid circuit. In one embodiment, the pump is configured to increase a pressure of the heat conducting fluid medium. In one embodiment, the fluid circuit further comprises a second heat exchanger configured to enable air cooling of the heat conducting fluid medium. In one embodiment, the fluid circuit further comprises a tank configured to store preconditioned heat conducting fluid medium. In one embodiment, the fluid circuit further comprises an expansion valve configured to decrease the pressure of the heat conducting fluid medium. In one embodiment, the fluid circuit further comprises one or more resistive heaters.

In one embodiment, the thermal regulation system further includes an electronic control unit configured to monitor and control the flow of heat conducting fluid medium to the fluid circuit. In one embodiment, the electronic control unit is further configured to monitor conditions of the battery pack of the electric vehicle. In one embodiment, the electronic control unit comprises a communications engine configured to receive at least one of a desired route of travel, expected ambient environmental conditions, or a combination thereof.

Another embodiment of the present disclosure provides an electric vehicle having a thermal regulation system configured to convert an external source of electrical energy to an alternative supply of on board stored energy for use in conditioning a temperature of a battery pack, including a battery pack, the battery pack selectively rechargeable by an external charging station, and a thermal regulation system including a fluid circuit configured to circulate a heat conducting fluid medium, having at least one mechanism for affecting at least one of a temperature change, pressure change, or a combination thereof to the heat conducting fluid medium, wherein the at least one mechanism is powered by electrical power from an external charging station, and a heat exchanger configured to enable a transfer of thermal energy between heat conducting fluid medium and a battery pack of an electric vehicle.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view depicting an electric vehicle comprising a battery thermal regulation system configured to convert an external source of electrical energy to an alternative supply of onboard stored energy for later use, as well as enabling a temperature conditioning of the battery pack for improved output, duration and recharge performance, in accordance with an embodiment of the disclosure.

FIG. 2 is an exploded perspective view depicting an electric vehicle battery pack coupleable to a battery thermal regulation system configured to convert an external source of electrical energy to an alternative supply of onboard stored energy for later use, in accordance with an embodiment of the disclosure.

FIG. 3 is a block diagram depicting a battery thermal regulation system configured to convert an external source of electrical energy to an alternative supply of onboard stored energy for later use, in accordance with an embodiment of the disclosure.

FIG. 4 is a block diagram depicting a battery thermal regulation system configured to convert an external source of electrical energy to an alternative supply of onboard stored energy for later use, in accordance with an alternative embodiment of the disclosure.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

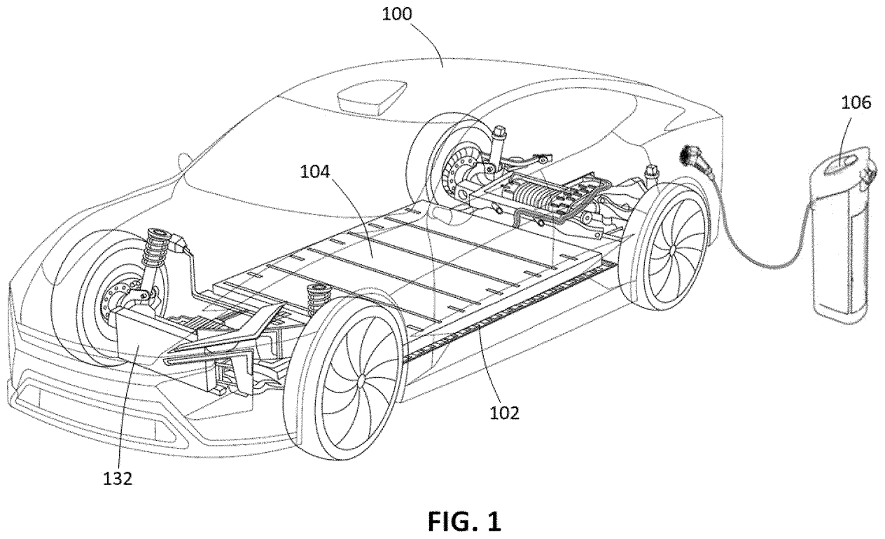

Referring to FIG. 1, an electric vehicle 100 comprising a battery thermal regulation system 102 configured to convert an external source of electrical energy to an alternative supply of onboard stored energy for later use, as well as enabling a temperature conditioning of the battery pack 104 for improved output, duration and recharge performance, is depicted in accordance with an embodiment of the disclosure. As depicted, the battery pack 104 can represent a sealed battery cell compartment containing clusters of individual battery cells (sometimes referred to as “battery modules”) and other battery related components. The assembled battery pack 104 can be mounted to the frame or chassis of the vehicle 100 and in some embodiments can be positioned adjacent to a cabin floor of the vehicle 100, thereby maintaining a low center of gravity. For example, the battery pack 104 may be positioned below the passenger compartment, which is generally considered an ideal location as the battery pack 104 maintains a low center of gravity of the vehicle 100, and is spaced away from the outer body of the vehicle, and therefore less prone to being damaged in a collision.

Various embodiments of the present disclosure will be described in detail with reference to the drawings, wherein like reference numerals represent like parts and assemblies throughout the several views. Various directions and orientations, such as “upward,” “downward,” “top,” “bottom,” “upper,” “lower”, etc. are generally described herein with reference to the drawings in the usual gravitational frame of reference, regardless of how the components may be oriented.

Additionally, the terms “battery,” “cell,” and “battery cell” may be used interchangeably and may refer to any of a variety of different cell types, chemistries and configurations including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other battery type/configurations. The term “battery pack” as used herein refers to multiple individual batteries contained within a single piece or multi-piece housing, the individual batteries electrically interconnected to achieve the desired voltage and capacity for a particular application. The term “electric vehicle” as used herein may refer to an all-electric vehicle, also referred to as an EV, a plug-in hybrid vehicle, also referred to as a PHEV, or a hybrid vehicle, also referred to as a HEV, where a hybrid vehicle refers to a vehicle utilizing multiple propulsion sources one of which is an electric drive system.

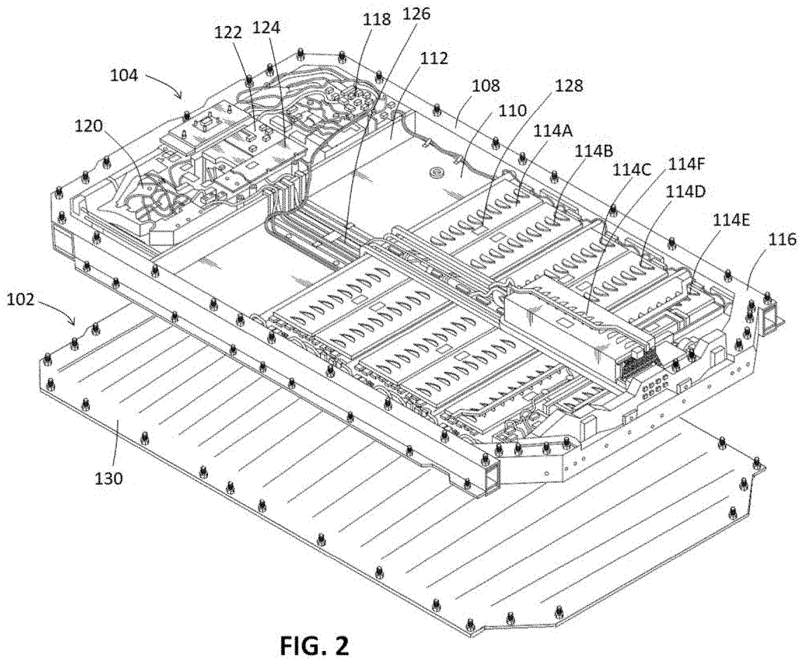

With additional reference to FIG. 2, an exploded view of an electric vehicle battery pack 104 coupleable to a battery thermal regulation system 102 configured to convert an external source of electrical energy to an alternative supply of onboard stored energy for later use, is depicted in accordance with an embodiment of the disclosure. As depicted, the battery pack 104 can include a rigid outer shell, sometimes referred to as a “battery tray” 108, representing a bottom and one or more sides of a structural vessel defining a compartment 110. Further, in embodiments, the battery tray 108 can include one or more structural supports, such as cross members 112, which can provide structural support to the battery pack 104, as well as surfaces within the compartment 110 on which other components of the battery pack can be affixed.

As further depicted, individual battery cells within the battery pack 104 can be grouped into distinct clusters 114A-F (sometimes referred to as “battery modules”). In addition to the battery modules 114A-F, a variety of components can be packed into the compartment 110 before a cover is affixed to a top surface 116 of the battery tray 108, thereby sealing the compartment 110. In some embodiments, the components can include an electrical current transmission system 118, safety system 120, battery management system 122 (including current management system 124), and a battery bus bar 126 interconnecting the various components 114A-F, 120, 122, and 124. Once the components have been positioned within the compartment 110, a cover can be affixed to the top surface 116 via a plurality of fasteners, adhesive, or a combination thereof.

In some embodiments, the battery management system 122 or other components of the multi-cell battery pack can include one or more sensors 128 for monitoring a physical state of the individual cells during operation. Such sensors include, but are not limited to measurement of temperature, pressure, voltage, amperage, and other ambient conditions (e.g., the presence of smoke or fumes, the presence of liquid, etc.) within the battery tray 108. Data from the sensors 128 can then be used by hardware and software to make intelligent decisions to control a temperature of the individual cells, so that the temperature within any individual cell stays within an acceptable operating range. Additionally, the battery management system 122, sometimes in combination with the electrical current transmission system 118, can be configured to enable information gathered by the one or more sensors 128 to flow into and out of the battery pack 104. The battery management system 122 can include mixed signal integrated circuits that incorporate both analog and digital circuits, such as one or more types of digital memory and special registers to hold battery data.

With continued reference to FIG. 1, in some embodiments, the battery pack 104 can be actively charged by an external charging station 106. During recharge the individual battery cells act as electrolytic cells by converting electrical energy to chemical energy, which in some cases can generate a significant amount of heat. Generally, the amount of heat generated by a battery pack 104 during recharge is the square of the rate of electrical charging. Therefore, for modern high-capacity batteries that charge at fast rates, very large amounts of heat can be generated. In particular, modern charging systems such as direct current fast charging (“DCFC”) and other “level 3” charging systems are designed to charge at high rates of around 50 kW or more. The battery pack 104 must nonetheless be maintained within a safe operating temperature while charging, in order to ensure that the battery cells are not damaged or degraded.

Once the battery pack 104 has been charged, during vehicle operation the individual battery cells discharge energy as galvanic cells by converting chemical energy to electrical energy (e.g., for use by the electric motors). During high rates of discharge (e.g., when the vehicle is under heavy acceleration and/or driving up a hill, etc.), the individual cells can generate a significant amount of heat. The heat produced by a high rate of discharge within an individual cell is generally a function of an electrical current and an internal electrical resistance of the cell. The cells are generally more sensitive to high temperatures when a voltage within the cell is relatively high. This volatility is dependent upon cell chemistry (e.g., lithium-ion reaction, etc.) and varies among different types of cells contemplated for use.

It has been observed that optimal battery cell performance is more likely to occur within a desired temperature range (e.g., 40-45° C., etc.), with a maximum/not to exceed temperature (e.g., 60° C.) being above the desired temperature range. In rare cases, individual battery cells within a battery pack 104 can exhibit thermal characteristics above a desired temperature range (e.g., above the maximum/not to exceed temperature), which may result in a failure (e.g., thermal runaway, etc.) of the individual cell. During such an occurrence, heat energy from the cell exhibiting the thermal characteristics can propagate into nearby and adjacent cells, thereby creating the potential for a chain reaction thermal event across multiple battery cells. For example, self-ignition of a battery cell may occur when the temperature of the cell reaches a temperature in a range of between about 120° C. and about 150° C.

Conversely, recent studies have indicated that operating an electric vehicle 100 in cold ambient weather conditions can result in a decrease in performance in available range. In particular, some studies suggest that a particular vehicle's range during the colder winter months may be about 60% of a typical expected range during the warmer summer months. Accordingly, it has been observed that optimal battery cell performance is most likely to occur within the desired temperature range (e.g., 40-45° C., etc.), with a decrease in performance observed below the lower end of the range.

Actively powering the battery thermoregulation system 102 with the rechargeable battery pack 104, can adversely affect the operational range of the electric vehicle 100. Accordingly, with obtaining optimal performance in mind, the battery thermoregulation system 102 of the present disclosure enables conversion an external source of electrical energy (e.g., external charging station 106) to onboard stored thermal energy (e.g., in the form of a pressurized or heated fluid medium) for later use, thereby enabling improved output, duration and recharge performance.

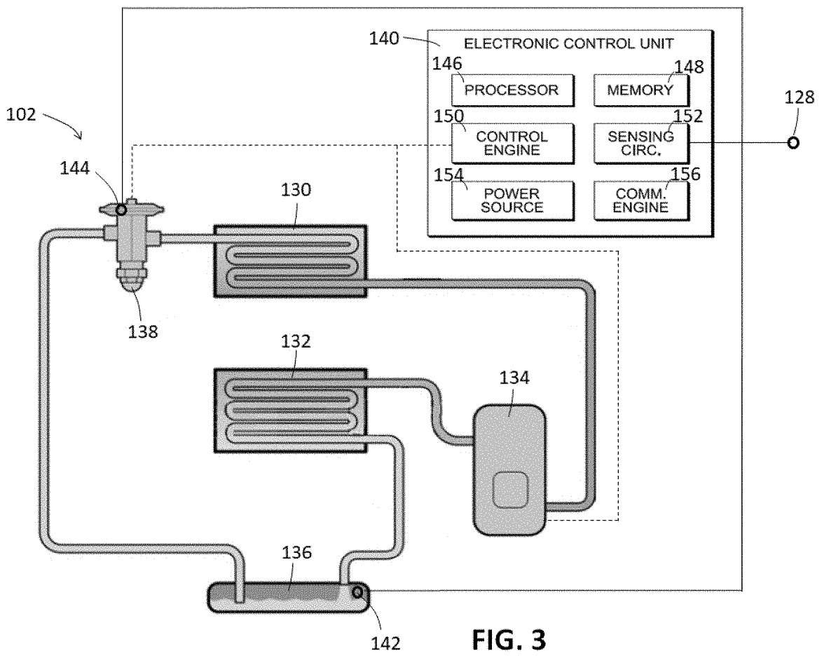

With additional reference to FIG. 3, a block diagram for a battery thermal regulation system 102 configured to convert an external source of electrical energy to an alternative supply of onboard stored energy for later use (e.g., battery conditioning, heating/cooling cabin, etc.), is depicted in accordance with an embodiment of the disclosure. As depicted, the battery thermal regulation system 102 can include a first heat exchanger 130, which in some embodiments can be operably coupled to the battery pack 104 (as depicted in FIG. 2), thereby enabling heat exchange between a heat conducting fluid medium passing through the first heat exchanger 130 and the battery pack 104. In some embodiments, the first heat exchanger 130 can include a labyrinth of conduit or plurality of cross tubes through which a heat conducting fluid medium can pass, thereby enabling heating and/or cooling of the heat exchanger 130, and in turn temperature regulation of the battery pack 104. Further, in some embodiments, the heat exchanger 130 can include a mass of a temperature regulatable material configured to act as a temperature buffer or bank of thermal energy to maintain a temperature within a desired range of temperatures, as thermal energy is transferred to the battery pack 104.

Additionally, in some embodiments, the battery thermoregulation system 102 can include an optional second heat exchanger 132 (e.g., in the form of a radiator as depicted in FIG. 1) configured to enable heat exchange between a heat conducting fluid medium passing through the second heat exchanger 132 and the ambient environment (e.g., a flow of air over the second heat exchanger 132). The use of the additional heat exchangers is also contemplated. In some embodiments, the temperature regulation system 102 can further include a pump or compressor 134, pressurized storage tank 136, expansion valve 138, and an electronic control unit (ECU) 140 configured to monitor and control the battery thermal regulation system 102.

In operation, a source of externally electrical energy (e.g., from an external charging station 106) can power the compressor 134, which can pressurize a heat conducting fluid medium provided pump for circulation of the heat conducting fluid medium through the battery thermal regulation system 102. According to the kinetic theory of gases, as the pressure of the heat conducting fluid medium rises, so does the temperature. In an effort to shed the increase in temperature, the pressurized heat conducting fluid medium can be circulated through the second heat exchanger 132. Excess pressurized heat conducting fluid medium can be stored in a pressurized storage tank 136 for use upon demand, which can be thermally isolated/insulated from other components of the system 102 and the ambient environment, thereby enabling maintenance of a target temperature or range of target temperatures. Accordingly, in some embodiments, a source of the external electric energy from the charging station 106 can be converted and stored in the form of a pressurized fluid medium, which can be later used to provide cooling to the battery pack 104 upon demand.

For example, when cooling of the battery pack 104 is desired, the pressurized heat conducting fluid medium stored in the storage tank 136 can be passed through an expansion valve 138, thereby rapidly decreasing both the pressure and temperature of the heat conducting fluid medium. The low temperature heat conducting fluid medium can then be passed through the first heat exchanger 130, thereby providing cooling to the battery pack 104 (e.g., absorbing heat energy from the battery pack 104 as the fluid passes through the first heat exchanger 130). The ECU 140 can be configured to monitor the battery thermal regulation system 102 and battery 104 through one or more sensors 128, 142, 144, and to control of the flow of heat conducting fluid medium through the battery thermal regulation system 102 (e.g., operation of the compressor 134, expansion valve 138, etc.).

The ECU 140 or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application specific integrated circuit (ASIC) or field programmable gate array (FPGA), for example, or as a combination of hardware and software, such as by a microprocessor system and a set of program instructions that adapt the engine to implement the particular functionality, which (while being executed) transform the microprocessor system into a special-purpose device.

An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

In some embodiments, ECU 140 can include a processor 146, memory 148, control engine 150, sensing circuitry 152, and power source 154. Optionally, in embodiments, ECU 140 can further include a communications engine 156. Processor 146 can include fixed function circuitry and/or programmable processing circuitry. Processor 136 can include any one or more of a microprocessor, a controller, a DSP, an ASIC, an FPGA, or equivalent discrete or analog logic circuitry. In some examples, processor 136 can include multiple components, such as any combination of one or more microprocessors, one or more controllers, one or more DSPs, one or more ASICs, or one or more FPGAs, as well as other discrete or integrated logic circuitry. The functions attributed to processor 146 herein may be embodied as software, firmware, hardware or any combination thereof.

Memory 148 can include computer-readable instructions that, when executed by processor 146 cause ECU 140 to perform various functions. Memory 148 can include volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

Control engine 150 can include instructions to control the components of ECU 140 and instructions to selectively control a flow of the heat conducting fluid medium through the first and second heat exchangers 130, 132. For example, in some embodiments, the control engine 150 can be configured to selectively activate the compressor 134, thereby enabling pressurization of the heat conducting fluid medium for storage in the storage tank 136, and to selectively open the expansion valve 138, thereby enabling selective use of the stored thermal energy through cooling of the first heat exchanger 130.

In embodiments, sensing circuitry 152 can be configured to sense a variety of conditions related the battery cells or modules 114A-F. For example, sensing circuitry 142 can be configured to sense at least one of a temperature, pressure, voltage, amperage, or other ambient condition (e.g., the presence of smoke or fumes, the presence of liquid, etc.) directly or indirectly associated with each module 114A-F, for example via sensors 128. Thereafter, the control engine 150 can control a flow of heat conducting fluid medium through the battery thermal regulation system 102 to affect thermal regulation of the battery 104. For optimal performance of the battery thermal regulation system 102, in some embodiments, one or more sensors 142, 144 positioned within the fluid conduit of the battery thermal regulation system 102 can be configured to monitor conditions (e.g., temperature, pressure, etc.) of the heat conducting fluid medium during operation.

Power source 154 is configured to deliver operating power to the components of ECU 140. In embodiments, the power source 154 can be electrically powered by an external charging station 106, although the power source 154 can also be coupled to the battery 104 or other power generation circuit to selectively provide power to the power source 154 and the absence of external power.

Optionally, communications engine 156 can include any suitable hardware, firmware, software, or any combination thereof for communicating with other components of the vehicle and/or external devices (e.g., charging station, etc.). Under the control of processor 146, communication engine 156 can receive downlink telemetry from, as well as send uplink telemetry to one or more external devices using an internal or external antenna. In addition, communication engine 156 can facilitate communication with a networked computing device and/or a computer network.

For example, in some embodiments, the communications engine 156 can be configured to receive information from a driver regarding a desired travel route (e.g., including a desired departure time and en route travel time); for example, in some embodiments, the desired travel route can be obtained from the vehicle's navigation unit (e.g., GPS). In some embodiments, communication engine 156 can additionally be configured to receive or autonomously gather weather data, including an expected ambient environmental temperature along the desired travel route. This information can be used by the battery management system 122 to anticipate energy usage and discharge requirements along the desired route, thereby enabling the battery management system 122 to compare actual, sensed conditions of the battery modules 114A-F to expected conditions of the individual cells for a given environmental temperature along the travel route.

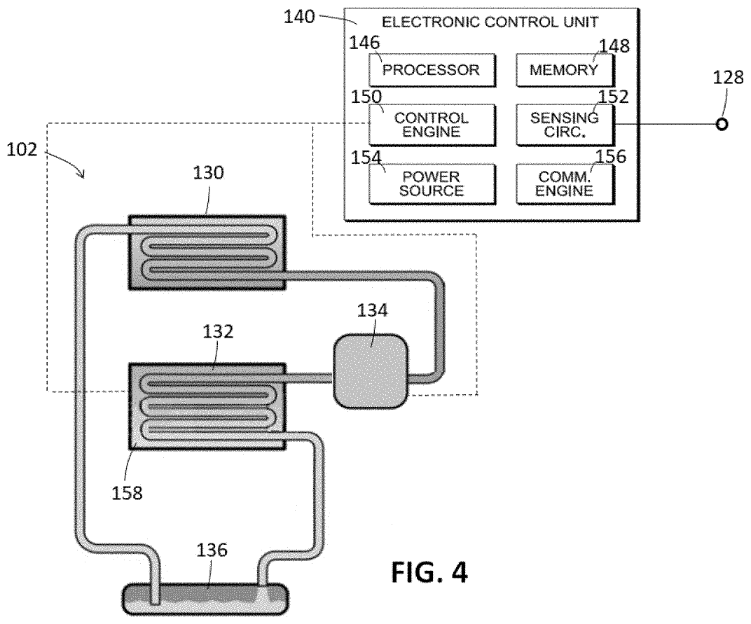

In some embodiments, the battery thermal regulation system 102 can leverage an external source of power to preheat or cool a block of material or other medium, to later provides heating and/or cooling to the battery pack 104. For example, with reference to FIG. 4, a block diagram for a battery thermal regulation system 102 configured to convert an external source of electrical energy to an onboard stored supply of thermal energy is depicted in accordance with an embodiment of the disclosure, wherein like reference numerals represent like parts, assemblies and functionalities to those depicted and described in FIG. 3.

In some embodiments, the battery thermal regulation system 102 can include one or more heating elements 158 (e.g., electrically resistive heating elements powered by power source 154) configured to condition the heat conductive fluid medium. Thereafter, the heat conductive fluid medium can be stored (e.g., in tank 136) for later use in conditioning a temperature of the battery pack 104. Accordingly, embodiments of the present disclosure provide an electric vehicle configured to harness electrical power provided by an external charging station to precondition a fluid to regulate the temperature of the rechargeable battery during recharge and subsequent use for optimal performance.

The invention is further illustrated by the following embodiments:

An thermal regulation system for an electric vehicle configured to convert an external source of electrical energy to an alternative supply of on board stored energy for use in conditioning a temperature of a battery pack, the thermal regulation system comprising:

a fluid circuit configured to circulate a heat conducting fluid medium, the fluid circuit comprising at least one mechanism, for affecting at least one of a temperature change, pressure change, or a combination thereof to the heat conducting fluid medium, wherein the at least one mechanism is powered by electrical power from an external charging station, and a heat exchanger configured to enable a transfer of thermal energy between heat conducting fluid medium and a battery pack of an electric vehicle.

A system or method according to any embodiment, wherein the fluid circuit further comprises a pump configured to actively circulate the heat conducting fluid medium through the fluid circuit.

A system or method according to any embodiment, wherein the pump is configured to increase a pressure of the heat conducting fluid medium.

A system or method according to any embodiment, wherein the fluid circuit further comprises a second heat exchanger configured to enable air cooling of the heat conducting fluid medium.

A system or method according to any embodiment, wherein the fluid circuit further comprises a tank configured to store preconditioned heat conducting fluid medium.

A system or method according to any embodiment, wherein the fluid circuit further comprises an expansion valve configured to decrease the pressure of the heat conducting fluid medium.

A system or method according to any embodiment, wherein the fluid circuit further comprises one or more resistive heaters.

A system or method according to any embodiment, further comprising an electronic control unit configured to monitor and control the flow of heat conducting fluid medium to the fluid circuit.

A system or method according to any embodiment, wherein the electronic control unit is further configured to monitor conditions of the battery pack of the electric vehicle.

A system or method according to any embodiment, wherein the electronic control unit comprises one or more sensors for monitoring a physical state of one or more individual cells of the battery pack during operation.

A system or method according to any embodiment, wherein the electronic control unit comprises one or more sensors for monitoring at least one of a temperature or pressure of the heat conducting fluid medium to aid in controlling electrical power to a pump.

A system or method according to any embodiment, wherein the electronic control unit comprises one or more sensors for monitoring at least one of a temperature or pressure of the heat conducting fluid medium to aid in controlling electrical power to an expansion valve.

A system or method according to any embodiment, wherein the electronic control unit comprises a communications engine configured to receive at least one of a desired route of travel, expected ambient environmental conditions, or a combination thereof.

A system or method according to any embodiment, wherein the thermal regulation system is mounted to a surface of the battery pack.

An electric vehicle comprising the thermal regulation system according to any embodiment of the disclosure.

Various embodiments of systems, devices, and methods have been described herein.

These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. An thermal regulation system for an electric vehicle configured to convert an external source of electrical energy to an alternative supply of onboard stored energy for use in conditioning a temperature of a battery pack, the thermal regulation system comprising:
a fluid circuit configured to circulate a heat conducting fluid medium, the fluid circuit comprising at least one mechanism for affecting at least one of a temperature change, pressure change, or a combination thereof to the heat conducting fluid medium, wherein the at least one mechanism is powered by electrical power from an external charging station, and a heat exchanger configured to enable a transfer of thermal energy between heat conducting fluid medium and a battery pack of an electric vehicle.

2. The thermal regulation system of claim 1, wherein the fluid circuit further comprises a pump configured to actively circulate the heat conducting fluid medium through the fluid circuit.

3. The thermal regulation system of claim 2, wherein the pump is configured to increase a pressure of the heat conducting fluid medium.

4. The thermal regulation system of claim 1, wherein the fluid circuit further comprises a second heat exchanger configured to enable air cooling of the heat conducting fluid medium.

5. The thermal regulation system of claim 1, wherein the fluid circuit further comprises a tank configured to store preconditioned heat conducting fluid medium.

6. The thermal regulation system of claim 1, wherein the fluid circuit further comprises an expansion valve configured to decrease the pressure of the heat conducting fluid medium.

7. The thermal regulation system of claim 1, wherein the fluid circuit further comprises one or more resistive heaters.

8. The thermal regulation system of claim 1, further comprising an electronic control unit configured to monitor and control the flow of heat conducting fluid medium to the fluid circuit.

9. The thermal regulation system of claim 8, wherein the electronic control unit is further configured to monitor conditions of the battery pack of the electric vehicle.

10. The thermal regulation system of claim 8, wherein the electronic control unit comprises a communications engine configured to receive at least one of a desired route of travel, expected ambient environmental conditions, or a combination thereof.

11. An electric vehicle having a thermal regulation system configured to convert an external source of electrical energy to an alternative supply of on board stored energy for use in conditioning a temperature of a battery pack, the electric vehicle comprising:
a battery pack, the battery pack selectively rechargeable by an external charging station; and
a thermal regulation system including a fluid circuit configured to circulate a heat conducting fluid medium, having at least one mechanism for affecting at least one of a temperature change, pressure change, or a combination thereof to the heat conducting fluid medium, wherein the at least one mechanism is powered by electrical power from an external charging station, and a heat exchanger configured to enable a transfer of thermal energy between heat conducting fluid medium and a battery pack of an electric vehicle.

12. The electric vehicle of claim 11, wherein the fluid circuit further comprises a pump configured to actively circulate the heat conducting fluid medium through the fluid circuit.

13. The electric vehicle of claim 12, wherein the pump is configured to increase a pressure of the heat conducting fluid medium.

14. The electric vehicle of claim 11, wherein the fluid circuit further comprises a second heat exchanger configured to enable air cooling of the heat conducting fluid medium.

15. The electric vehicle of claim 11, wherein the fluid circuit further comprises a tank configured to store preconditioned heat conducting fluid medium.

16. The electric vehicle of claim 11, wherein the fluid circuit further comprises an expansion valve configured to decrease the pressure of the heat conducting fluid medium.

17. The electric vehicle of claim 11, wherein the fluid circuit further comprises one or more resistive heaters.

18. The electric vehicle of claim 11, further comprising an electronic control unit configured to monitor and control the flow of heat conducting fluid medium to the fluid circuit.

19. The electric vehicle of claim 18, wherein the electronic control unit is further configured to monitor conditions of the battery pack of the electric vehicle.

20. The electric vehicle of claim 18, wherein the electronic control unit comprises a communications engine configured to receive at least one of a desired route of travel, expected ambient environmental conditions, or a combination thereof.
